(19) United States
(12) Patent Application Publication
(10) Pub. No.: US 2016/0236469 A1
(43) Pub. Date: Aug. 18, 2016

(54) LIQUID DISCHARGING HEAD, LIQUID DISCHARGING UNIT, AND DEVICE TO DISCHARGE LIQUID

(71) Applicant: Masami Iwama, Ibaraki (JP)

(72) Inventor: Masami Iwama, Ibaraki (JP)

(73) Assignee: Ricoh Company, Ltd., Tokyo (JP)

(21) Appl. No.: 15/016,402

(22) Filed: Feb. 5, 2016

(30) Foreign Application Priority Data
Feb. 12, 2015 (JP) 2015-024867

(51) Int. Cl. B41J 2/14

(52) U.S. Cl. CPC B41J 2/14201; B41J 2002/14491

(57) ABSTRACT

A liquid discharging head includes a substrate, at least two heads arranged on the substrate in a longitudinal direction of the liquid discharging head. Each of the at least two heads includes a plurality of nozzles configured to discharge a liquid, and a plurality of pressure generators corresponding to the plurality of nozzles, wherein a drive signal imparted to the pressure generators is supplied to each of the at least two heads from one side (supplying side) in an arrangement direction of the pressure generators, two adjacent heads of the at least two heads are arranged with the far side of each of the two adjacent heads from the one side placed next to each other or the near side thereof placed next to each other, and the far side of each of the two adjacent heads is mutually connected with each other.

### CROSS-REFERENCE TO RELATED APPLICATIONS

This patent application is based on and claims priority pursuant to 35 U.S.C. §119 to Japanese Patent Application No. 2015-024867 on Feb. 12, 2015 in the Japan Patent Office, the entire disclosure of which is hereby incorporated by reference herein.

### BACKGROUND

1. Technical Field

The present invention relates to a liquid discharging head, a liquid discharging unit, and a device to discharge liquid.

2. Background Art

As a liquid discharging head to discharge a liquid, those having two or more heads arranged in the longitudinal direction are known.

For example, multiple short heads (head chip) are arranged in the width direction of a recording medium, which is referred to as multi-array heads.

When a drive signal is impart to each pressure generator (drive element) corresponding to multiple nozzles in a single head, a configuration to conduct one side supply is known, which provides the drive signal from one side of the multiple pressure generators aligned in the nozzle arrangement direction.

In this one-side supply configuration, as the pressure generators are located farther away from the supplying side of the drive signal, the rounding of the waveforms of the drive signal increases. Accordingly, the discharging property of the nozzles changes depending on the positions thereof.

For this reason, if multiple heads are arranged side by side, the discharging property changes at joints of adjacent heads in the arrangement direction. As a consequence, the image quality deteriorates at the joint portions.

### SUMMARY

According to the present invention, provided is an improved liquid discharging head which includes a substrate, at least two heads arranged on the substrate in a longitudinal direction of the liquid discharging head. Each of the at least two heads includes a plurality of nozzles configured to discharge a liquid and a plurality of pressure generators corresponding to the plurality of nozzles, wherein a drive signal imparted to the pressure generators is supplied to each of the at least two heads from one side (supplying side) in an arrangement direction of the pressure generators, two adjacent heads of the at least two heads are arranged with the far side of each of the two adjacent heads from the one side placed next to each other or the near side thereof placed next to each other, and the far side of each of the two adjacent heads is mutually connected with each other.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic planar diagram illustrating a liquid discharging head according to an embodiment of the present disclosure;

FIG. 2 is a cross section along the direction (longitudinal direction of liquid chamber) vertical to the nozzle arrangement direction of an example of a head;

FIG. 3 is a cross section along the direction (latitudinal direction of liquid chamber) of the nozzle arrangement of the head illustrated in FIG. 2;

FIG. 4 is a diagram illustrating a circuit schematic including a head drive controller to drive a liquid discharging head;

FIG. 5 is a graph illustrating an example of a drive signal;

FIG. 6 is a graph illustrating an example of a drive signal to which rounding occurs to;

FIG. 7 is a diagram for use in a description of the relation between the nozzle position and the discharging speed to the supplying side of the drive signal in a head;

FIG. 8 is a diagram for use in a description of a first embodiment of the present disclosure;

FIG. 9 is a circuit schematic of the equivalence circuit of the first embodiment;

FIG. 10 is a diagram for use in a description of the first embodiment.

FIG. 11 is a diagram for use in a description of the first embodiment of the present disclosure;

FIG. 12 is a schematic diagram illustrating an example of a device to discharge a liquid according to an embodiment of the present disclosure; and

FIG. 13 is a diagram illustrating an example of a liquid discharging unit of the device to discharge a liquid illustrated in FIG. 12.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Preferred embodiments of the present invention are described in detail below with reference to the accompanying drawings. Although the presently preferred embodiments of the present invention are described with various technically preferred limitations, the scope of the invention should not be construed as limited by the embodiments discussed below. It should not be construed that all of elements of the embodiments discussed below are essential to the invention unless specifically stated as such

According to the present disclosure, the deterioration of the image quality at joint portions of head chips is subdued.

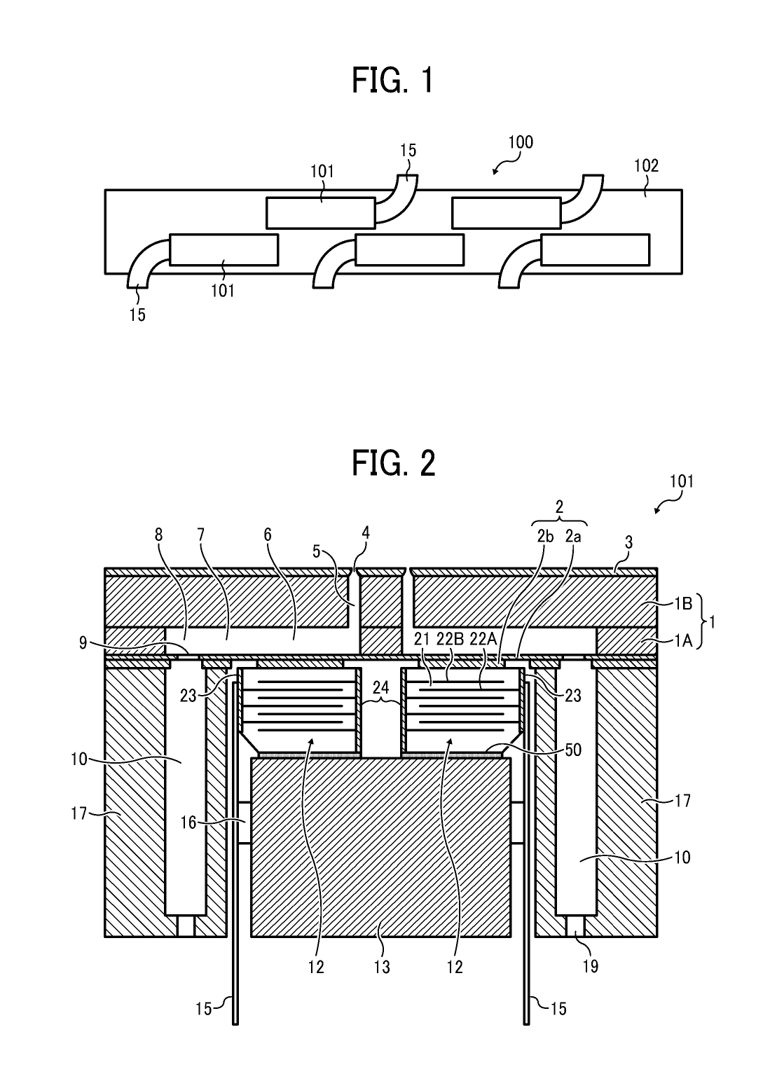

Embodiments of the present disclosure are described with reference to the accompanying drawings. An embodiment of the liquid discharging head according to the present disclosure is described with reference to FIG. 1. FIG. 1 is a schematic planar diagram illustrating a liquid discharging head.

A liquid discharging head 100 includes multiple heads 101 arranged on a substrate 102 along the longitudinal direction, i.e., the nozzle arrangement direction in a zigzag way.

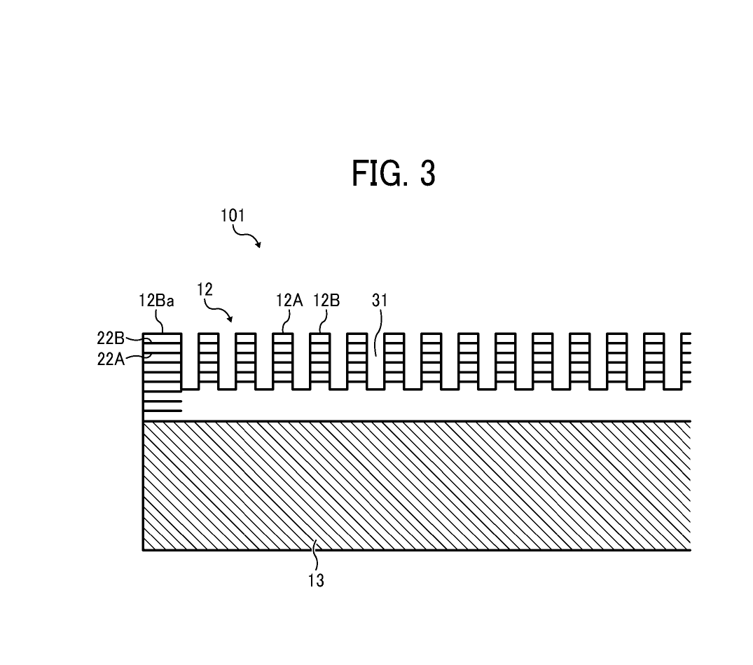

Next, an embodiment of the head 101 is described with reference to FIGS. 2 and 3. FIG. 2 is a cross section along the direction (longitudinal direction of liquid chamber) vertical to the nozzle arrangement direction of the head and FIG. 3 is a cross section along the direction (latitudinal direction of liquid chamber) of the nozzle arrangement of the head.

This head 101 includes, for example, a flow path plate 1 configured of two SUS substrates 1A and 1B, a vibration plate member 2 jointed with one surface of the flow path plate 1, and a nozzle plate 3 jointed another surface of the flow path plate 1.

By these, multiple individual liquid chambers 6 serving as individual paths communicating with multiple nozzles 4 to discharge droplets (droplets of liquid) via a path 5 individually, a fluid resistance 7 doubled as a supplying path through which the liquid is supplied to the individual liquid chamber 6, and a liquid introduction unit 8 communicating with the individual liquid chamber 6 via the fluid resistance 7.

The liquid is supplied to the liquid introduction unit 8 from a common liquid chamber 10 formed on a frame member 17 via a supplying mouth 9 formed on the vibration plate member 2.

The vibration plate member 2 has each vibration area 2a constituting the walls corresponding to each individual liquid chamber 6 and an insular convex part 2b outside the surface (opposite side of the liquid chamber 6) of the vibration area 2a. The insular convex part 2b of the vibration plate member 2 is jointed on the upper surface (jointed surface) of a piezoelectric element 12A having a pillar-like form of a laminate piezoelectric member 12 serving as pressure generator (drive element, actuator) to transform the vibration area 2a. In addition, the opposite surface of the laminate piezoelectric member 12 is jointed with a base plate 13.

The piezoelectric member 12 is formed by alternately laminating a piezoelectric layer 21 and inside electrodes 22A and 22B. Each of the inside electrodes 22A and 22B is drawn to the end surface, i.e., the lateral side substantially vertical to the vibration plate member 2 of the piezoelectric member 12 and connected to end surface electrodes (external electrodes) 23 and 24 formed on the lateral side. A displacement in the lamination direction occurs by applying a voltage between the end surface electrodes (exterior electrodes) 23 and 24. The exterior electrodes 23 is set as individual exterior electrode (individual electrode) and the exterior electrode 24 is used as common exterior electrode (common electrode).

This piezoelectric member 12 is processed by half cut dicing to form grooves 31 (illustrated in FIG. 3) and a particular number of piezoelectric elements (piezoelectric pillar) 12A and 12B having a pillar-like form are formed on the piezoelectric member 12 in a pectinate manner spaced a predetermined distance therebetween.

Although the piezoelectric elements 12A and 12B of the piezoelectric element 12 are the same, the piezoelectric element 12A is driven by a drive waveform (drive signal) and the piezoelectric element 12B is not driven by a drive waveform but simply used as a supporting pillar. In addition, the piezoelectric element 12B at the end of the piezoelectric member 12 is set as a piezoelectric element 12Ba, which has a greater breadth to draw the common electrode to the outside, and each of the inside electrodes 22A and 22B is provided to each end.

In addition, a flexible printed circuit (FPC) 15 serving as flexible wiring board to transmit a drive signal imparted to the piezoelectric element 12A is connected with the piezoelectric member 12.

The FPC 15 has an individual electrode wiring connected with the individual exterior electrode 23 of the piezoelectric element 12A to transmit a drive signal and a common electrode wiring connected with a common drawing-out electrode connected with the common electrode 24 of the multiple piezoelectric elements 12A drawn out to the piezoelectric element 12Ba at the end portion.

This FPC 15 includes a drive IC (driver IC) 16 to output a drive signal to the piezoelectric element 12A in accordance with image data.

On the nozzle plate 3, the nozzle 4 having a diameter of from 10 μm to 35 μm corresponding to each individual liquid chamber 6 is formed and jointed with the flow path plate 1 with an adhesive. A liquid repellent layer is provided to the discharging surface (surface along the discharging direction, opposite side to the liquid chamber 6) of the nozzle plate 3.

Furthermore, the frame member 17 made of, for example, an epoxy-based resin or polyphenylene sulfite by injection molding is jointed to the outer circumference of the piezoelectric actuator including these piezoelectric member 12, the base plate 13, the FPC 15, etc.

The frame member 17 includes the above-mentioned common liquid chamber 10. Moreover, a supplying mouth 19 to supply a liquid from outside to the common liquid chamber 10 is formed on the frame member 17 and the supplying mouth 19 is connected with a liquid supply source such as a sub-tank or a liquid tank.

In the head 101 having such a configuration, the piezoelectric element 12A contracts by, for example, lowering the voltage applied to the piezoelectric element 12A of the piezoelectric element 12 from a reference voltage. For this reason, the vibration area 2a of the vibration plate member 2 deforms, thereby inflating the volume of the individual liquid chamber 6. As a result, the liquid flows into the individual liquid chamber 6.

Thereafter, the piezoelectric element 12A is elongated in the lamination direction by raising the voltage applied to the piezoelectric element 12A of the piezoelectric element 12 to transform the vibration area 2a of the vibration plate member 2 toward the nozzle 4 direction, thereby contracting the volume of the individual liquid chamber 6. For this reason, the liquid in the liquid chamber 6 is pressurized so that the liquid is discharged through the nozzle 4.

Thereafter, the voltage applied to the piezoelectric element 12A of the piezoelectric element 12 is caused to be back to the reference voltage. Accordingly, the vibration area 2a of the vibration plate member 2 is back to the initial position so that the individual liquid chamber 6 inflates, which generates a negative pressure. At this point in time, the ink is supplied from the common liquid chamber 10 to the individual liquid chamber 6. After the vibration of the meniscus surface of the nozzle 4 decays and is stabilized, the system starts operations to discharge the next droplet.

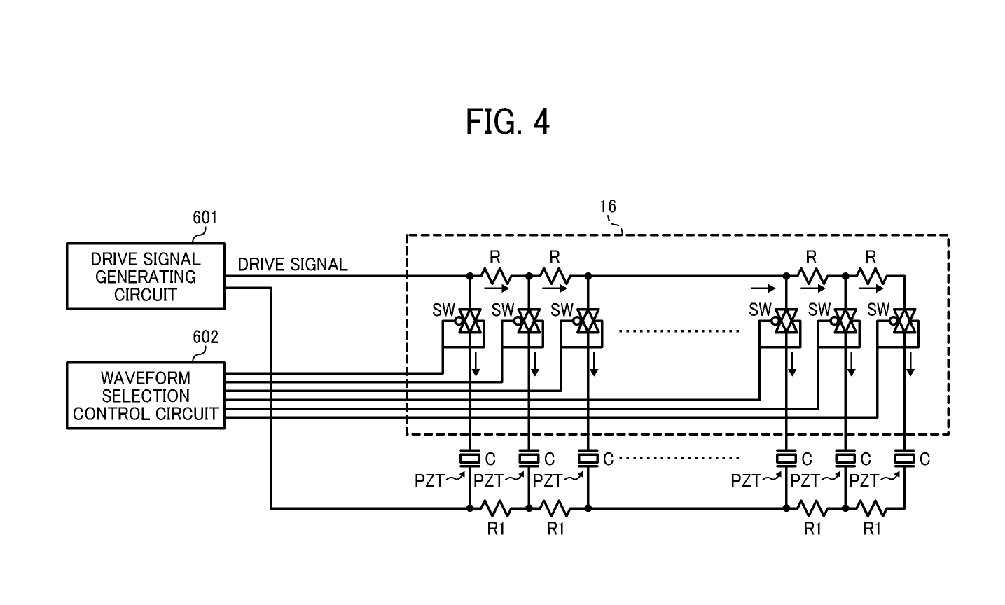

Next, a circuit schematic including a head drive controller to drive a liquid discharging head is described with reference to FIG. 4. FIG. 4 is a circuit schematic illustrating a circuit including a head drive controller of a single head.

As described above, the piezoelectric elements 12A (piezoelectric element PZT in this case) serving as multiple pressure generators corresponding to the nozzles 4 are arranged in a single head 101.

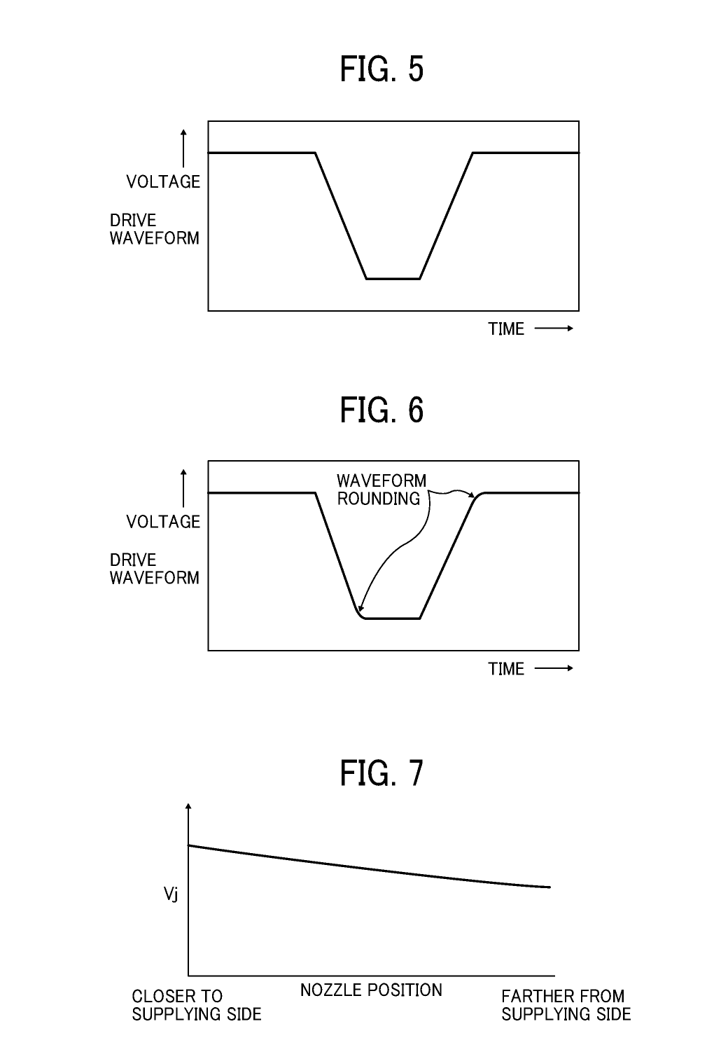

On the other hand, a drive signal generating circuit (drive signal source) 601 generates and outputs, for example, a drive signal (drive waveform) as illustrated in FIG. 5.

The drive signal generated by this drive signal generating circuit 601 is supplied to the drive IC 16 in the head 101 via a wiring member such as the FPC 15 and thereafter imparted to each piezoelectric element PZT via a switch SW serving as a selector configured of analogue switches included in the drive IC 16.

The waveform selection control circuit 602 outputs a signal to control on and off of the switch SW in accordance with image data. When the switch SW is on, the drive signal is input into the piezoelectric element PZT.

The supply (power supply) of the drive signal to the multiple piezoelectric elements PZT is configured to be a one-side supply, i.e., supply from one side (supplying side) of the arrangement direction of the piezoelectric elements.

Each of the lines of the multiple piezoelectric elements PZT and the switches SW aligned in the nozzle arrangement direction is either on the near or far side about the supplying side of the drive signal.

The supply circuit to supply the drive signal supplied from the drive signal generating circuit 601 to each switch SW and piezoelectric element PZT is a RC low-pass filter (LPF) circuit configured of a synthesized resistance component R of the inside wiring in the drive IC 16, a resistance component R1 of the common electrode wiring, and a capacitor component C of the piezoelectric element PZT when the switch SW is on.

The high frequency component of the drive signal is removed when the drive signal passes through this LPF. Therefore, the number of LPF's through which the drive signal passes increases as the line is situated farther from the supplying side of the drive signal. Consequently, rounding occurs to the waveform of the drive signal as illustrated in FIG. 6. In particular, as the number of the piezoelectric elements PZT that are driven at the same time increases, the number of LPF's increases, so that the amount of rounding of the drive signal increases.

Due to this rounding of the drive signal, discharging speed Vi becomes slower. For this reason, as illustrated in FIG. 7, the discharging speed Vi slows down from the nozzles located on the near side to the supplying side (power supplying side to the head) of a drive signal towards the nozzles located on the far side (opposite side to the supplying side).

In this liquid discharging head 100, as illustrated in FIG. 1, two adjacent heads (first and second heads) 101 are arranged in the head arrangement direction in such a manner that the far sides from the supplying sides (which is connected to the drive signal generating circuit 601 via the wiring member such as the FPC 15) of a drive signal are adjacent to each other. The two adjacent heads 101 may also be arranged in such a manner that the near sides from the supplying sides of a drive signal are next to each other.

That is, in the two adjacent heads 101, the discharging speed Vj changes in the reverse direction in the head arrangement direction. Therefore, for example, if the change amount of the discharging speed Vj of each head 101 is assumed to be substantially the same, the discharging speed Vj of the entire of the liquid discharging heads 100 is that the maximum change amount of the discharging speed Vj of the individual heads 101 is within the change amount of the discharging speed Vj of a single head 101.

Since the discharging speed Vj of the adjacent heads 101 and that at the joint portion thereof are almost the same, streaks stemming from the difference between the discharging speeds Vj are not highly visible. That is, the degradation of the image density at the joint portion is lessened, thereby improving the image quality.

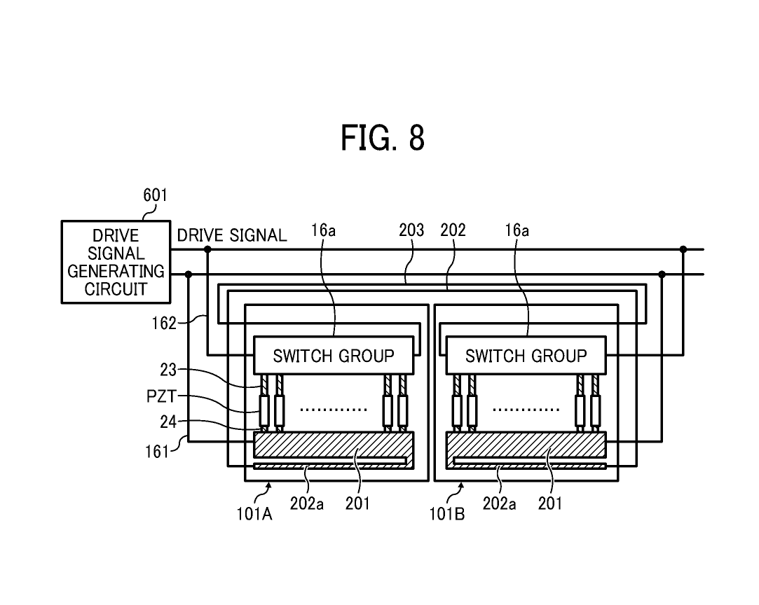

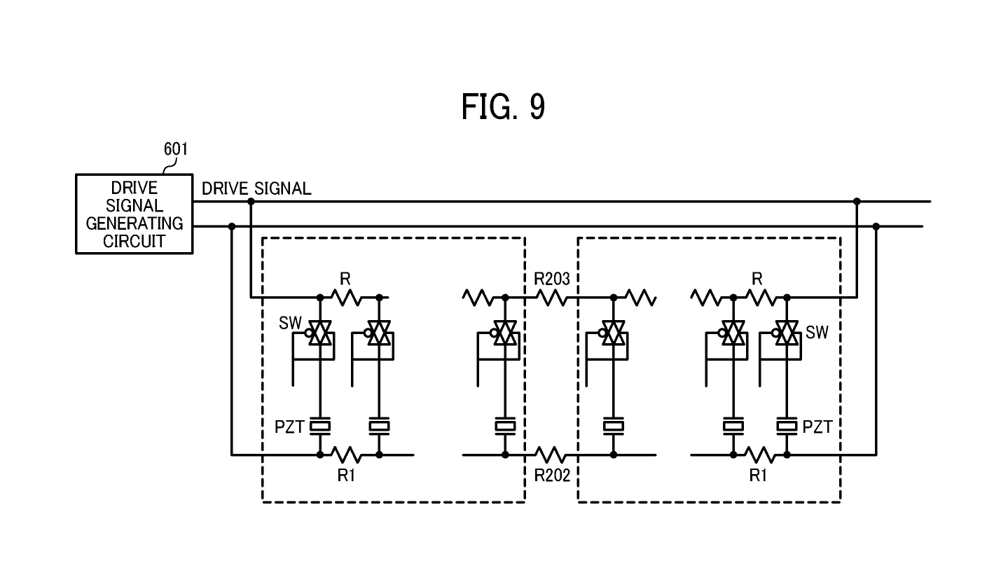

Next, the first embodiment of the present disclosure is described with reference to FIG. 8 and FIG. 9. FIG. 8 is a diagram for use in a description of the first embodiment and FIG. 9 is a circuit schematic of the equivalence circuit thereof.

The two adjacent heads (first and second heads) 101A and 101B have a common electrode wiring pattern 201 with which the common electrode 24 of each piezoelectric element PZT is connected along the arrangement direction of the multiple piezoelectric elements PZT. In addition, the individual electrodes 23 of each piezoelectric element PZT is connected with the switch SW serving as selector in the drive IC 16. The multiple switches SW are arranged in the arrangement direction of the piezoelectric elements PZT.

A supply wiring 161 of a drive signal from the drive signal generating circuit 601 is connected on one side (end) of the common electrode wiring pattern 201. In addition, a supply wiring 162 of a drive signal from the drive signal generating circuit 601 is connected with the switch SW on one side (end) of the multiple switches SW of the drive IC 16.

The two adjacent heads 101A and 101B are arranged with the far sides thereof from the supplying sides of the drive signal adjacent to each other.

The two adjacent heads 101A and 101B are mutually connected through the far sides of the common electrode wiring patterns 201 by a cross-linking wiring 202. Part of the cross-linking wiring 202 is configured of an inside wiring 202a of the heads 101A and 101B.

In addition, of the multiple switches SW constituting a switch group 16a of the two heads 101A and 101B, the switches SW located on the far sides from the supplying sides of the drive signal are mutually connected with each other on the opposite sides of the side (first side) connected with the piezoelectric elements PZT by a cross-linking wiring 203. The switch group 16a is included in the drive IC 16.

As illustrated in FIG. 9, the far side from the supplying side of the drive signal of the head 101A on the common electrode wiring pattern 201 and the far side from the supplying side of the drive signal of the head 101B on the common electrode wiring pattern 201 are connected via a cross-linking resistance R202 of the cross-linking wiring 202.

In addition, the opposite side of the side connected with the piezoelectric element PZT of the switch SW located on the far side from the supplying side of the drive signal of the head 101A is connected with the side connected with the piezoelectric element PZT of the switch SW located on the far side of the supplying side of the drive signal of the head 101B via the cross-linking resistance R203 of the cross-linking wiring 203.

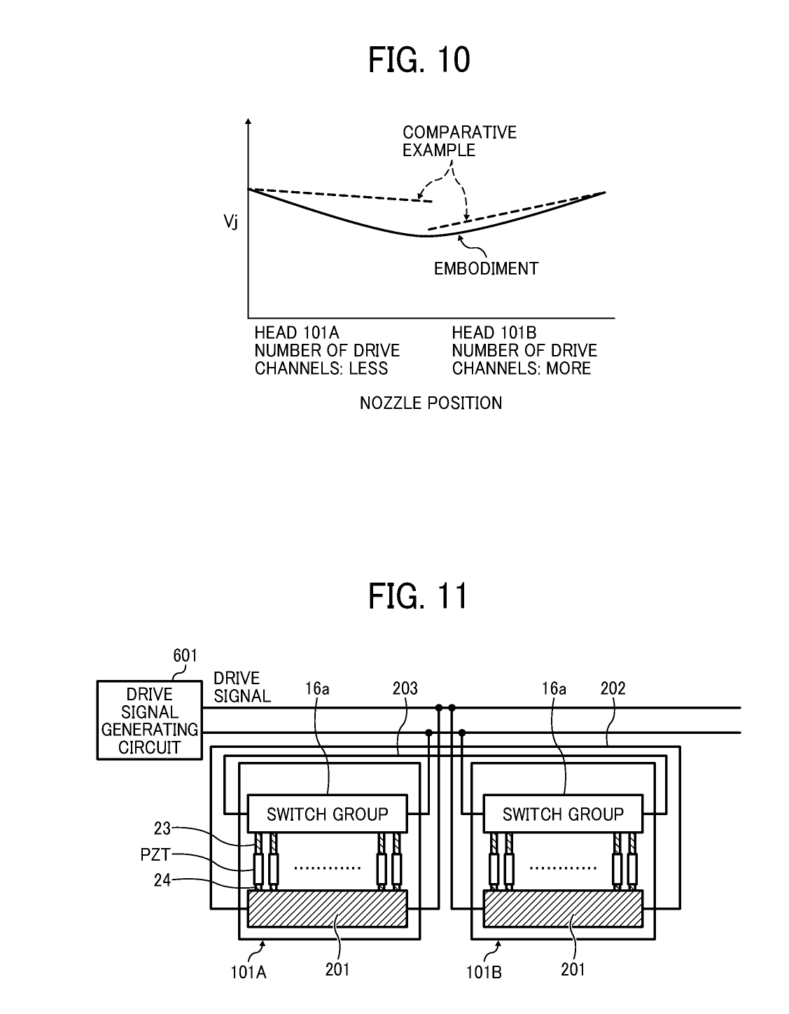

Next, the working of the embodiment having such a configuration is described with reference to FIG. 10. FIG. 10 is a diagram for use in a description of this embodiment.

In the two heads 101A and 101B, the number of nozzles to discharge a liquid at the same time (This is referred to as drive channel) may be different. For example, as illustrated in FIG. 10, there may be a case in which the number of drive channels at the same time of the head 101A is small while the number of drive channels at the same time of the head 101B is large or vice versa.

Unlike this embodiment, if no connection is made by the cross-linking wirings 202 and 203 (this is a “Comparative Embodiment”), the lowering amount of the discharging speed Vj on the far side from the supplying side of a drive signal varies between the head 101A and the head 101B as illustrated in the broken lines in FIG. 10.

That is, if the far sides relative to the supplying sides of a drive signal are arranged next to each other but the number of drive channels is different, the discharging speed Vj at the joint portion of the adjacent two heads varies, so that the image quality deteriorates at the joint portion.

Taking account into this, this embodiment has a configuration in which the far ends relative to the supplying side of a drive signal of the two heads are mutually connected.

For this reason, for example, when the number of drive channels of the head 101A is small while the number of drive channels of the head 101B is large, the power is supplied to the piezoelectric element PZT on the far side from the supplying side of the head 101B via the wiring of the drive signal of the head 101A and the cross-linking wirings 202 and 203.

Therefore, the current through the head 101A increases, so that the discharging speed Vj in the head 101A lowers greatly.

As a result, as illustrated in the solid line in FIG. 10, the discharging speed Vj in the head 101A lowers greatly and becomes almost the same as that of the head 101B, so that the difference between both discharging speeds Vj is small at the joint portion of the two heads 101A and 101B.

For this reason, the change in the image quality is not highly visible, thereby improving the entire print quality.

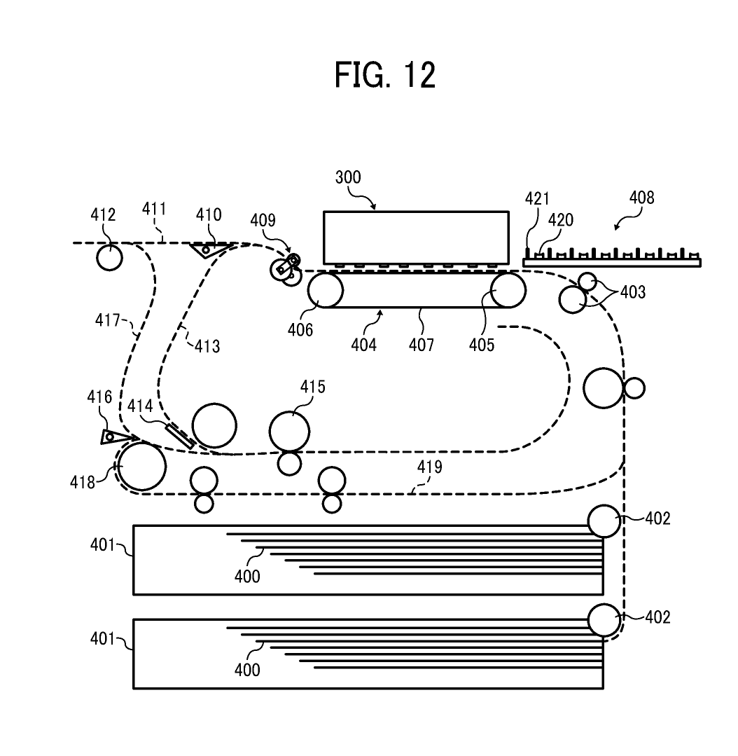

Next, the second embodiment of the present disclosure is described with reference to FIG. 12. FIG. 12 is a diagram for use in a description of the second embodiment of the present disclosure.

In this embodiment, the two heads 101A and 101B are arranged in such a manner that the near sides thereof from the supplying sides of a drive signal are next to each other.

The other configuration is the same as those in the first embodiment.

The same working in such a configuration is obtained as in the first embodiment.

In addition, in each embodiment, both the common electrode wiring pattern and the switches are connected on the far sides from the supplying sides of a drive signal. However, it is also suitable to have a configuration in which one of the common electrode wiring pattern and the switch is mutually connected on the far sides from the supplying side of the drive signal.

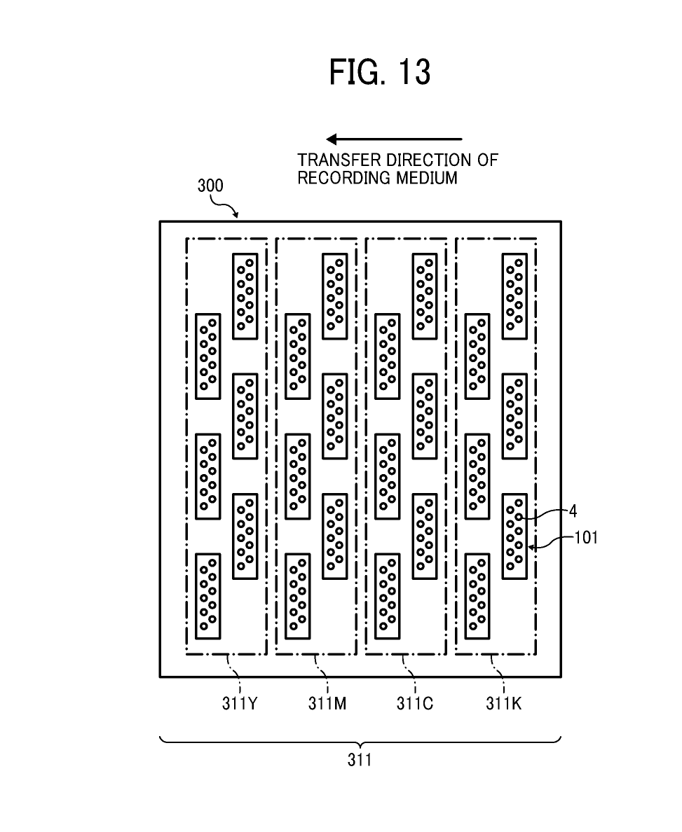

One embodiment of the device to discharge a liquid of the present disclosure is described with reference to FIG. 12 and FIG. 13. FIG. 12 is a diagram illustrating the device and FIG. 13 is a planar view of the liquid discharging unit of the device.

The device to discharge the liquid is a line-type image forming apparatus. A sheet 400 serving as a recording medium loaded in a sheet feeding tray 401 is transferred by a feeding roller 402 along the transfer path indicated by the doted lines. The sheet 400 transferred to the transfer path is transferred to a belt transfer unit 404 via a pair of timing adjusting and skew correcting rollers (i.e., registration rollers) 403.

The belt transfer unit 404 includes a transfer roller 405 driven on a timing, a tension roller 406, and a transfer belt 407 having an endless form stretched between the transfer roller 405 and the tension roller 406.

To hold the sheet 400 by the transfer belt 407 of the belt transfer unit 404, it is possible to use a device utilizing adsorption such as electrostatic adsorption and air adsorption and other known devices.

The sheet 400 is transferred by the belt transfer unit 404 while facing a liquid discharging unit 300 and each head 101 of each liquid discharging head 311 of the liquid discharging unit 300 is driven in accordance with image data to discharge liquid, thereby forming an image.

The liquid discharging unit 300 is configured of the multiple liquid discharging heads 100 of the first embodiment and includes a liquid discharging head 311Y, a liquid discharging head 311M, a liquid discharging head 311C, and a liquid discharging head 311K to discharge the liquid of yellow (Y), magenta (M), cyan (C), and black (K) as illustrated in FIG. 13.

The sheet 400 on which the image is formed by the liquid discharging unit 300 is transferred to a de-curling unit 409 where the sheet 400 is de-curled (curling correction).

The sheet 400 that has passed the de-curling unit 409 is ejected to an ejection roller 412 by a separation claw 410 via a transfer path 411 if the sheet 400 is ejected with no further processing.

In addition, when the sheet 400 is reversed before ejection or subject to printing in the opposite surface (duplex printing), the separation claw 410 is switched counterclockwise from the position illustrated in FIG. 12 and the sheet 400 passes through a transfer path 413 via a guide 414 to a hitting roller 415. The sheet 400 sent to the hitting roller 415 is transferred in the reverse direction by the hitting roller 415 in which the rotation direction is changed.

The sheet 400 that has passed the de-curling unit 409 is ejected to an ejection roller 412 via a second separation claw 416 and a transfer path 417 if the sheet 400 is ejected with no further processing.

In addition, in the case of duplex printing, the sheet 400 transferred in the reverse direction by the hitting roller 415 passes through a transfer path 419 via the second separation claw 416 switched counterclockwise from the position illustrated in FIG. 12 and a duplex reversing roller 418 to a pair of registration rollers 403.

In addition, to maintain and recover the performance of each head 101 of the liquid discharging unit 300, a maintenance and recover unit 408 is provided. The maintenance and recovery unit 408 includes a cap 420 to cap the nozzle surface of each head 101, a suction pump connected with the cap 420, and a wiper 422 to wipe ink remaining on the head when the ink is suctioned in the cap 420.

During maintenance and recovery, the liquid discharging unit 300 elevates and the maintenance and recovery unit 408 moves below each head 101 of the liquid discharging unit 300 to conduct maintenance and recovery. In addition, the cap 420 of the maintenance and recovery unit 408 serve as moisturizing cap to maintain the moisture of each head 101 of the liquid discharging unit 300 during stand-by. During non-printing, the liquid discharging unit 300 elevates and the maintenance and recovery unit 408 moves below the liquid discharging unit 300 to conduct moisturizing capping.

By providing the liquid discharging head or the liquid discharging unit including the liquid discharging head relating to the present disclosure, the deterioration of the image quality in the head arrangement direction is subdued to form quality images.

In the present disclosure, the device to discharge a liquid represents a device to discharge a liquid to a medium (object) to which the liquid is attachable.

The device to discharge a liquid may include not only a portion discharging a liquid but also a unit relating to feeding, transferring, ejecting recording media, and other devices referred to as a pre-processing device, a post-processing device, etc.

In addition, the device to discharge a liquid includes typical devices such as a recording device, a printing device, an image forming apparatus, a droplet discharging device, a liquid discharging device, a process fluid applicator, and a 3D modeling device.

In addition, the device to discharge a liquid is not limited only to a device which can produce meaningful and visible images such as texts and figures by a liquid attached to what the liquid is attachable. For example, the device to discharge a liquid may form meaningless patterns or 3D images.

What the liquid is attachable means what the liquid can be attached even temporarily. When alternative terms such as sheets, media, recording media, recording sheets, recording paper, powder layer are used instead of the wording of what the liquid is attachable, the wording includes what any kinds of liquids can be attached unless otherwise specified.

Specific examples of the materials of what a liquid can be attached include anything to which a liquid can be attached even temporarily, such as paper, thread, fiber, cloth, leather, metal, plastic, glass, wood, and ceramics.

In addition, the liquid includes ink, process fluid, DNA sample, resists, pattern materials, and binding agents.

The device to discharge a liquid includes both a serial type device in which the liquid discharging head is caused to move and a line type device in which the liquid discharging head is not caused to move, unless otherwise specified.

The liquid discharging unit represents a part integrated with a portion causing to discharge a liquid. For example, the liquid discharging unit includes a combination of multiple liquid discharging heads and a combination of the liquid discharging head and at least one of a head tank, a carriage, a supplying mechanism, a maintenance mechanism, and the main scanning moving mechanism.

For example, the liquid discharging unit includes a part in which a liquid discharging head is integrated with a head tank, a part in which a liquid discharging head is integrated with a carriage, and a part in which a liquid discharging head is integrated with a head tank and a carriage.

Also, it is possible to add a filter unit to those.

In addition, the liquid discharging unit includes a part in which a liquid discharging head is integrated with a maintenance mechanism, a part in which a liquid discharging head is integrated with a maintenance mechanism and a main scanning moving mechanism, and a part in which a liquid discharging head is integrated with a main scanning moving mechanism and a supplying mechanism in a serial type device.

The main scanning mechanism is configured by combining a carriage, a guiding member to guide the carriage, or a combination of those with a drive source and a moving mechanism of the carriage. The supplying mechanism includes a mounting unit to which a main tank is mounted, a tube, a head tank, etc. The maintenance mechanism is a combination of at least two of a cap, a wiper, a suction device such as a suction pump connected with the cap, and a dummy discharging receiver.

Furthermore, the liquid discharging unit may have a configuration in which the mechanism to transfer what a liquid is attached from the mechanism described in the embodiments.

In addition, the liquid discharging head has no specific limit to the pressure generating device used therein. For example, other than the piezoelectric actuator in the embodiments described above, it is possible to use a thermal actuator using the thermoelectric conversion element such as a heat element and an electrostatic actuator including a vibration plate and a counter electrode.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A liquid discharging head comprising:
a substrate;
at least first and second heads arranged on the substrate in a longitudinal direction of the liquid discharging head, each of the at least first and second heads comprising:
a plurality of nozzles configured to discharge a liquid; and
a plurality of pressure generators corresponding to the plurality of nozzles,
wherein a drive signal imparted to the pressure generators is supplied to each of the first and second heads from one side in an arrangement direction of the pressure generators from a drive signal source,
wherein the first and second heads arranged with far sides thereof from the one side adjacent to each other or near sides thereof from the one side adjacent to each other and
wherein the far sides of the first and second heads are mutually connected with each other.

2. The liquid discharging head according to claim 1,
wherein the first and the second heads individually include a common electrode wiring pattern commonly connected with the pressure generators, and
wherein the first and second heads are mutually connected through far sides of the common electrode wiring patterns therein from the one side.

3. The liquid discharging head according to claim 1,
wherein each of the first and second heads includes multiple selectors configured to select the pressure generators to which the drive signal is imparted,
wherein the multiple selectors are arranged in the arrangement direction of the pressure generators, and
wherein the multiple selectors individually have a first side and an opposite side to the first side,
the first sides of the multiple selectors of the first head are connected to the pressure generators of the first head,
the first sides of the multiple selectors of the second heads are connected to the pressure generators of the second head, and
the opposite sides of the multiple selectors of the first and second heads are mutually connected with each other.

4. A liquid discharging unit comprising:
the liquid discharging head of claim 1.

5. A device to discharge a liquid comprising:
one of the liquid discharging head of claim 1 and the liquid discharging unit of claim 4.
